(19) United States
(12) Patent Application Publication
(10) Pub. No.: US 2015/0356380 A1
(43) Pub. Date: Dec. 10, 2015

(54) SYSTEM, PRINTING APPARATUS, CONTROL METHOD, AND RECORDING MEDIUM

(71) Applicant: CANON KABUSHIKI KAISHA, Tokyo (JP)

(72) Inventor: Hiroaki Nakata, Kawasaki-shi (JP)

(21) Appl. No.: 14/732,548

(22) Filed: Jun. 5, 2015

(30) Foreign Application Priority Data
Jun. 9, 2014 (JP) 2014-118622

(51) Int. Cl. G06K 15/02; G06K 15/00

(52) U.S. Cl. CPC G06K 15/02; G06K 15/407

(57) ABSTRACT

A printing apparatus includes a storage unit configured to store information input by a user operation, a generation unit configured to generate an extended file based on the information stored by the storage unit, and a transmission unit configured to transmit the extended file to an information processing apparatus, wherein a print setting function of the information processing apparatus is extended based on the extended file.

### BACKGROUND OF THE INVENTION

1. Field of the Invention

The present invention relates to a system, a printing apparatus, a control method, and a recording medium.

2. Description of the Related Art

In recent years, a “general-purpose printer driver”, which is a printer driver that can be used in any type of printers, has been researched and developed. The general-purpose printer driver, however, is configured to support only functions that are common to printers and thus there is the issue that a function that is unique to each printer cannot be used with the general-purpose printer driver.

Thus, U.S. Patent Application Publication No. 2012/0147414 discusses a technique in which an information processing apparatus accesses a storage device of an apparatus, such as a printer and a server on a network, so as to acquire a setting file including information on the printer function and extends the function of the printer driver.

With this technique, a function unique to each printer can be used even with a general-purpose printer driver.

In the system discussed in U.S. Patent Application Publication No. 2012/0147414, however, the setting file acquired from the storage device is always the same.

### SUMMARY OF THE INVENTION

It is often possible to add a new printing function to a printer or to limit a printing function of the printer by changing a device setting of the printer. However, if an acquired setting file is always the same, a problem arises in that a change performed to the device setting is not reflected on a function for, for example, the print setting of the printer driver.

A configuration for addressing the above issue will be described in the present specification. The present specification is directed to a configuration in which a printer provides a function setting file in accordance with a status of the printer and a client thus a print setting function in accordance with the function setting file can be provided.

According to an aspect of the present invention, a printing apparatus includes a storage unit configured to store information input by a user operation, a generation unit configured to generate an extended file based on the information stored by the storage unit, and a transmission unit configured to transmit the extended file to an information processing apparatus, wherein a print setting function of the information processing apparatus is extended based on the extended file.

Further features of the present invention will become apparent from the following description of exemplary embodiments (with reference to the attached drawings).

### BRIEF DESCRIPTION OF THE DRAWINGS

FIG. 1 is a diagram illustrating an example of a printing system that includes a printing apparatus and an information processing apparatus.

FIG. 2 is a block diagram illustrating a hardware configuration of the printing system.

FIG. 3 is a diagram illustrating a software configuration for performing a process relating to the printing system.

FIG. 4 is a diagram illustrating a driver management process in the information processing apparatus.

FIGS. 5A, 5B, and 5C are diagrams each illustrating a file structure managed by the information processing apparatus.

FIGS. 6A and 6B are diagrams each illustrating an example of a user interface (UI) screen that can be displayed in the information processing apparatus.

FIG. 7 is a diagram illustrating an example of a paper type database.

FIG. 8 is a flowchart illustrating data processing in the printing apparatus.

FIG. 9 is a diagram illustrating a process of the software of the printing system.

FIGS. 10A and 10B are diagrams each illustrating an example of a message.

FIGS. 11A and 11B are diagrams each illustrating an example of a message.

FIGS. 12A and 12B are diagrams each illustrating an example of a message.

FIG. 13 is a diagram illustrating an example of the UI screen that can be displayed in the information processing apparatus.

FIGS. 14A and 14B are diagrams each illustrating an example of a function setting file.

FIG. 15 is a diagram illustrating a process of the software of the printing system.

FIGS. 16A and 16B are diagrams illustrating an example of a message.

FIG. 17 is a diagram illustrating an example of a message.

FIG. 18 is a flowchart illustrating data processing in the information processing apparatus.

### DESCRIPTION OF THE EMBODIMENTS

Hereinafter, exemplary embodiments for implementing the present invention will be described with reference to the drawings.

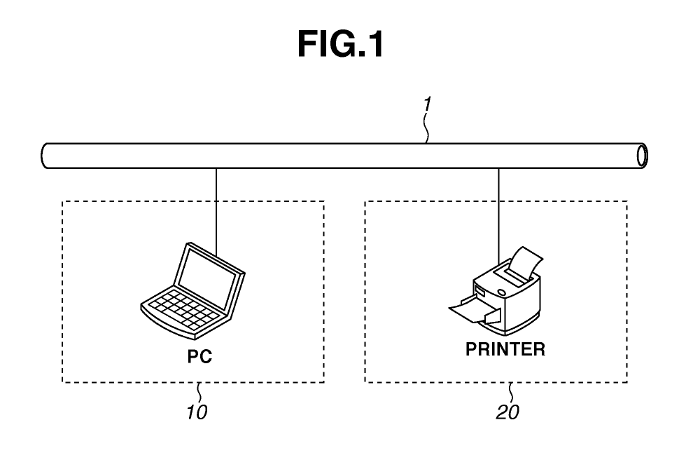

FIG. 1 is a diagram illustrating an example of a printing system that includes a printing apparatus and an information processing apparatus according to an exemplary embodiment.

As illustrated in FIG. 1, the printing system includes a personal computer (PC) 10 and a printer 20. The present invention can be applied not only to the system according to the present exemplary embodiment but also to a system in which a plurality of PCs 10 and a plurality of printers 20 are connected.

The PC 10 and the printer 20 are interconnected via a local area network (LAN) 1. The LAN 1 supports an Ethernet (registered trademark) communication scheme. The PC 10 and the printer 20 may be connected to each other by another connection mode, such as a wired LAN, Bluetooth (registered trademark), and a Universal Serial Bus (USB).

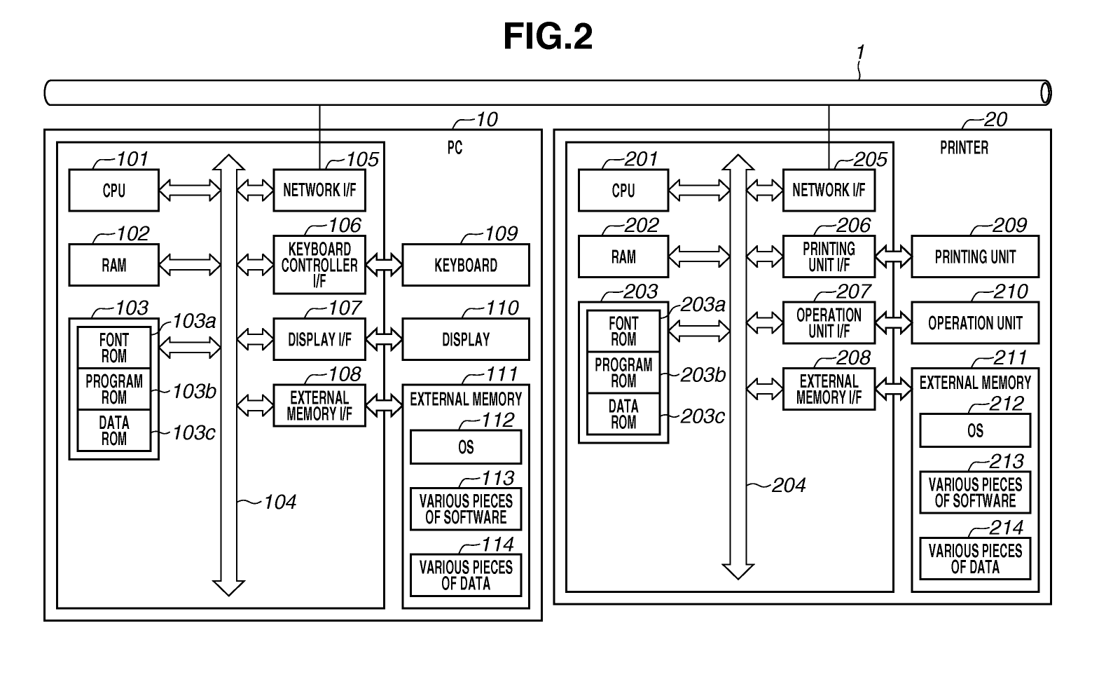

FIG. 2 is a block diagram illustrating a hardware configuration of the printing system illustrated in FIG. 1. The PC 10 will be described.

In the PC 10 illustrated in FIG. 2, a central processing unit (CPU) 101 collectively controls devices connected to a system bus 104 in accordance with a program stored in a random-access memory (RAM) 102. The RAM 102 also functions as a main memory, a work area, and the like of the CPU 101.

A read-only memory (ROM) 103 stores various pieces of programs and data and includes a font ROM 103a that stores various types of fonts, a program ROM 103b that stores a boot program, the basic input/output system (BIOS), and the like, and a data ROM 103c that stores various pieces of data.

A network interface (I/F) 105 is connected to the LAN 1 and performs a communication process. A keyboard controller I/F 106 controls a key input via a keyboard 109 or a pointing device (mouse) (not illustrated).

A display I/F 107 controls a display process of a display 110. An external memory I/F 108 controls an access to an external memory 111, such as a hard disk (HD).

The external memory 111 functions as a storage medium that stores an operating system (hereinafter, the OS) 112, various pieces of software 113 for the printing system according to the present exemplary embodiment, and various pieces of data 114, such as a user file, an edited file, and the like.

The type of the OS 112 is not particularly limited, but Microsoft Windows (registered trademark) is used in the present exemplary embodiment.

A configuration of the printer 20 will be described.

In the printer 20, a CPU 201 collectively controls devices connected to a system bus 204 in accordance with a program stored in a RAM 202. The RAM 202 functions as a main memory, a work area, and the like of the CPU 201 and is also used as an output information expansion area and an environmental data storage area.

The RAM 202 also includes a non-volatile RAM (NVRAM) area and is configured to be capable of expanding its memory capacity using an optional RAM to be connected to an expansion port (not illustrated).

A ROM 203 includes a font ROM 203a that stores various types of fonts, a program ROM 203b that stores a control program and the like to be executed by the CPU 201, and a data ROM 203c that stores various pieces of data. A network I/F 205 is connected to the LAN 1 and performs a communication process. A printing unit I/F 206 controls an interface for a printing unit 209 serving as a printer engine.

An operation unit 210 that is controlled via an operation unit I/F 207 is provided with an operation panel that receives a user operation. The operation panel is provided with a switch, a light-emitting diode (LED) display, and the like (not illustrated) that allow the user to operate the operation panel. An external memory I/F 208 controls an access to an external memory 211, such as an HD.

The external memory 211 functions as a storage medium that stores a device OS 212, various pieces of software 213 for the printing system according to the present exemplary embodiment, and various pieces of data 214, such as an extended generic printer description (GPD) file (extended file).

A GPD file is a data file that defines a print setting of a printer driver, and an extended GPD file is a data file to be used to extendedly define a print setting after a printer driver has been installed.

The CPU 201 can communicate with the PC 10 via the network I/F 205 and receives printer description language (PDL) data transmitted from the PC 10. Although the type of the PDL is not particularly limited, an extensible markup language paper specification (XPS) (Extensible Markup Language (XML) Paper Specification) format is used in the present exemplary embodiment.

The CPU 201 can output an image signal obtained by converting print data to the printing unit 209 via the printing unit I/F 206 in accordance with the control program and the like stored in the program ROM 203b of the ROM 203.

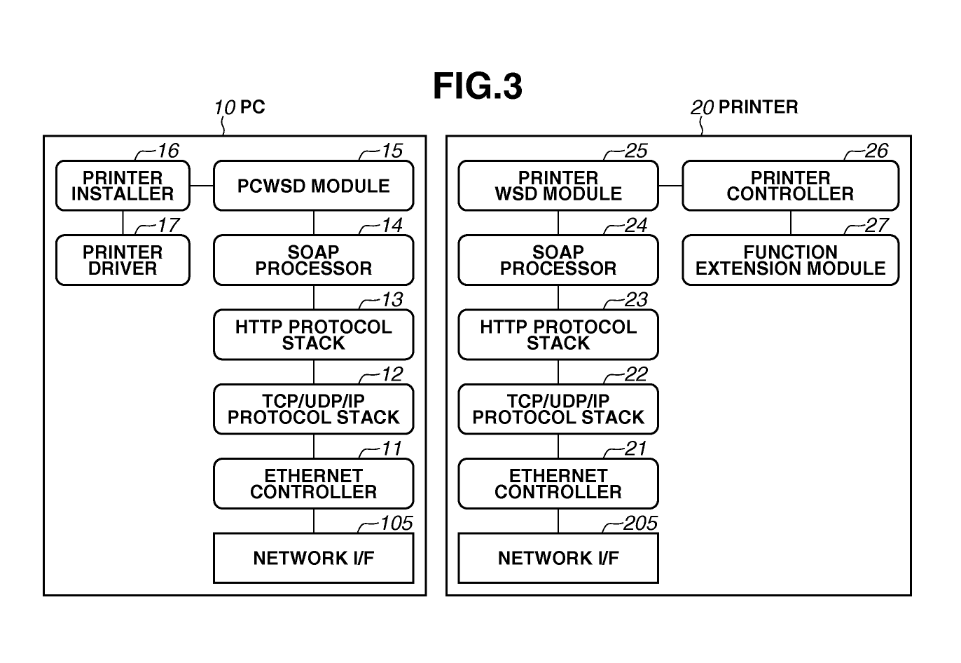

FIG. 3 is a diagram illustrating a software configuration for performing process relating to the printing system according to the present exemplary embodiment.

The software configuration of the PC 10 will be described.

In the PC 10 illustrated in FIG. 3, software components described hereinafter are stored in the external memory 111, and when being executed, the software components are loaded onto the RAM 102 and executed by the CPU 101.

An Ethernet controller 11 controls an Ethernet communication process via the network I/F 105. A transmission control protocol/user datagram protocol/Internet protocol (TCP/UDP/IP) protocol stack 12 arranged in a layer above the Ethernet controller 11 controls protocol communication using TCP/UDP/IP.

A hypertext transfer protocol (HTTP) protocol stack 13 arranged in a layer above the TCP/UDP/IP protocol stack 12 controls a communication process using HTTP. A simple object access protocol (SOAP) processor 14 controls a communication process using SOAP.

The SOAP is a communication protocol that is used in a web service technique for calling a process and retrieving data to a device from another device. A PC web services on devices (WSD) module 15 controls a WSD communication process via the SOAP processor 14.

The WSD is a type of web service technique of which specifications have been defined by Microsoft (registered trademark) and so on. A printer installer 16 is a program that searches for a device using a WSD communication and installs a printer driver 17 in the OS 112. In addition, the printer installer 16 extends the function of the printer driver 17 based on information obtained by the communication.

The software configuration of the printer 20 will be described.

Software components (described below) of the printer 20 are stored in the external memory 211, and when a process is to be started, the software components are loaded onto the RAM 202 and executed by the CPU 201. An Ethernet controller 21 controls an Ethernet communication process via the network I/F 205. A TCP/UDP/IP protocol stack 22 arranged in a layer above the Ethernet controller 21 controls TCP/UDP/IP protocol communication.

An HTTP protocol stack 23 arranged in a layer above the TCP/UDP/IP protocol stack 22 controls an HTTP communication process, and a SOAP processor 24 controls a SOAP communication process. A printer WSD module 25 controls a WSD communication process via the SOAP processor 24. The printer WSD module 25 is controlled by a printer controller 26.

The printer controller 26 performs a process relating to a device setting which is input via the operation unit 210. A function extension module 27 updates a function setting file in accordance with the device setting.

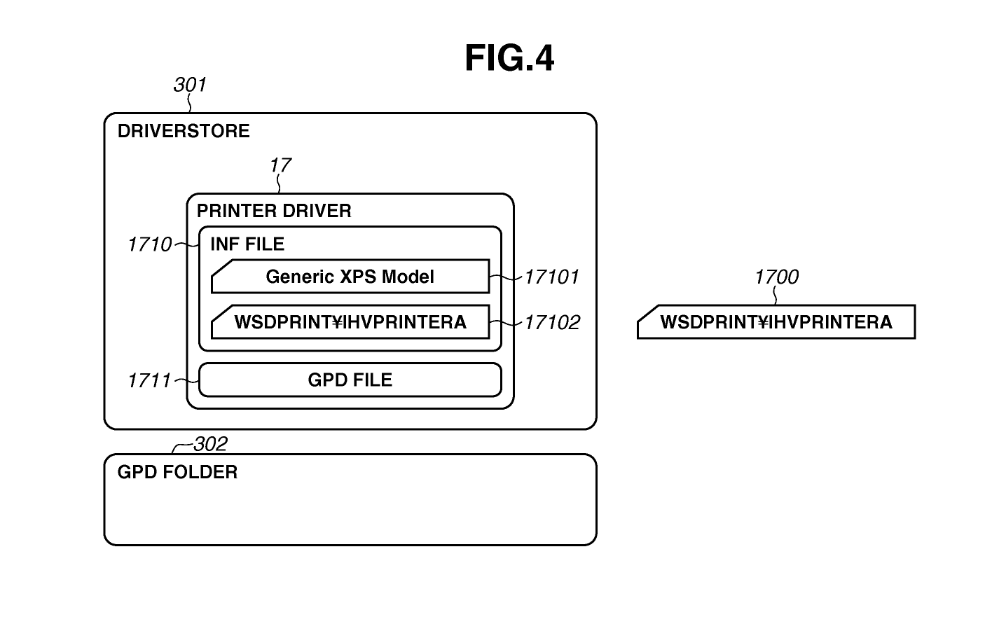

FIG. 4 is a diagram illustrating a driver management process in the information processing apparatus according to the present exemplary embodiment. Hereinafter, how the printer driver 17 is installed in the OS 112 will be described with reference to FIG. 4.

With reference to FIG. 4, the printer driver 17 is stored in an area called a driverstore 301 managed by the OS 112 and is managed. The printer driver 17 may be stored in advance in the driverstore 301 or stored at a later timing via the LAN 1 or the like.

The printer driver 17 includes at least an INF file 1710 that describes information for installation and a GPD file 1711 that defines the function setting file. The printer driver 17 may also include a conversion filter module, a resource file, and the like (not illustrated).

The INF file 1710 includes information on a model name 17101 and a hardware ID 17102. The hardware ID 17102 is an identifier for associating a device with a driver.

The printer installer 16 determines compatibility by determining whether a printer hardware ID 1700 included in attribute information obtained from the printer 20 matches the hardware ID 17102 described in the INF file 1710.

According to the present exemplary embodiment, the printer hardware ID 1700 obtained from the printer 20 is a character string “WSDPRINT¥IHVPRINTERA”. The character string in the hardware ID 17102 of the printer driver 17 is also “WSDPRINT¥IHVPRINTERA”, which matches the printer hardware ID 1700.

In a case where the printer hardware ID 1700 matches the hardware ID 17102 and it is determined that the printer driver 17 is compatible with the printer 20, the printer installer 16 copies the GPD file 1711 into a GPD folder 302. Through this operation, the printer driver 17 is installed and becomes available.

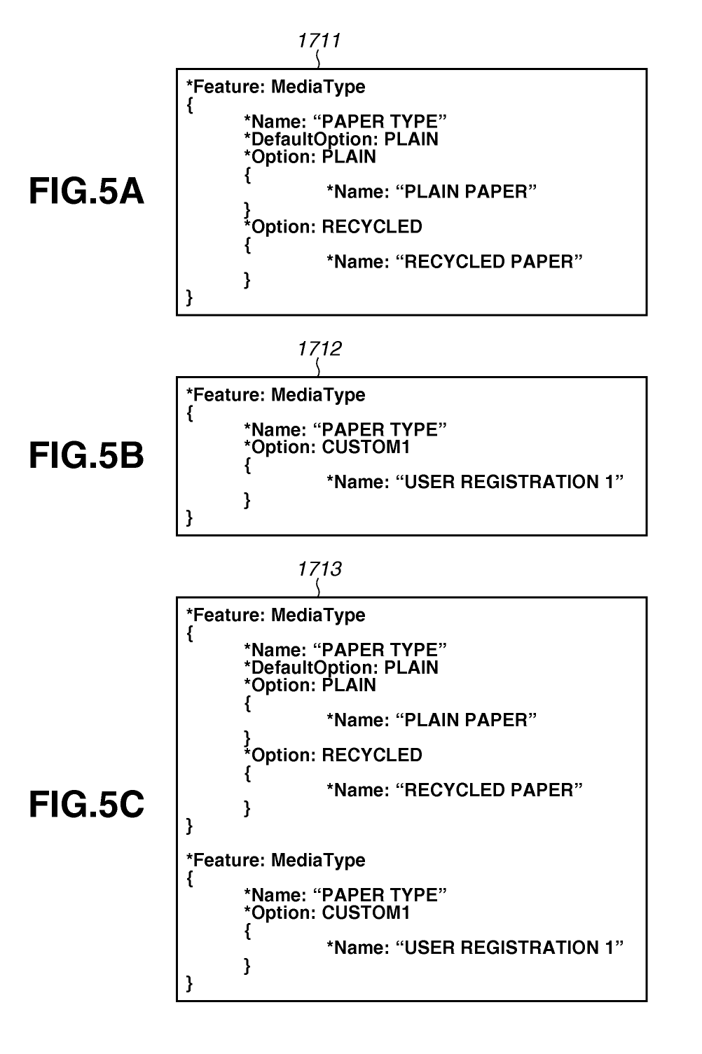

FIGS. 5A, 5B, and 5C are diagrams each illustrating a structure of a file managed by the information processing apparatus according to the present exemplary embodiment. In particular, an example illustrated in FIG. 5A is the GPD file 1711.

The GPD file 1711 defines various pieces of setting information that can be input via the printer driver 17. Examples of the setting information include the number of copies, paper orientation, a paper size, a paper type, a one-sided or two-sided option, and a paper feeding method. Among these examples, an example of defining the setting information of the paper type is described in the present exemplary embodiment.

Specifically, the GPD file 1711 describes two pieces of information of “PLAIN (plain paper)” and “RECYCLED (recycled paper)” as a selectable paper type.

The values “PLAIN” and “RECYCLED” in an option attribute correspond to the IDs for a paper type specification reflected in a print command generated by the printer driver 17. In addition, the values “PLAIN PAPER” and “RECYCLED PAPER” in a name attribute correspond to wording displayed in the UI for a print setting provided by the printer driver 17.

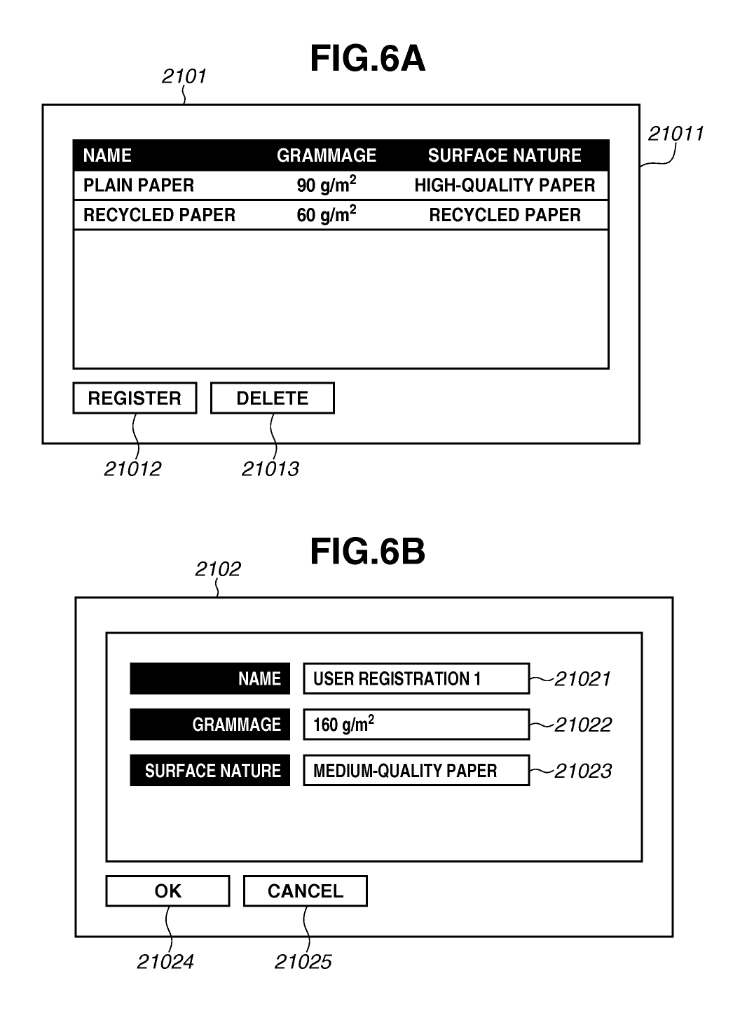

FIGS. 6A and 6B are diagrams each illustrating an example of a UI screen that can be displayed in the information processing apparatus according to the present exemplary embodiment. In particular, FIG. 6A illustrates a screen 2101 for registering a new paper type in the printer 20. Hereinafter, a setting process for user paper information received from a user will be described.

The paper types are defined by physical properties, such as a grammage and a surface nature, and the printer 20 is required to control printing based on the physical properties. However, there is sometimes a case in which physical properties of the type of paper that the user actually wants to use do not match any of the paper types defined in advance.

In order to accommodate such a situation, the printer 20 includes an input unit through which information on a new paper type can be registered together with the physical property thereof.

In FIG. 6A, the screen 2101 displays a table 21011 that contains a list of paper types that are currently registered. When a button 21012 is pressed, the screen 2101 is changed to a screen 2102 illustrated in FIG. 6B for inputting information on a new paper type.

In the screen 2101, when a button 21013 is pressed, among the registered paper types, a selected paper type can be deleted (only an element that the user has registered at a later timing can be deleted).

FIG. 6B illustrates the screen 2102 for inputting information on a new paper type, and the user inputs attributes such as a name, a grammage, and surface nature of the new paper type, respectively, in fields 21021, 21022, and 21023. In the screen 2102, when a button 21024 is pressed, the new paper type is registered, and the information on the new paper type is reflected in the table 21011.

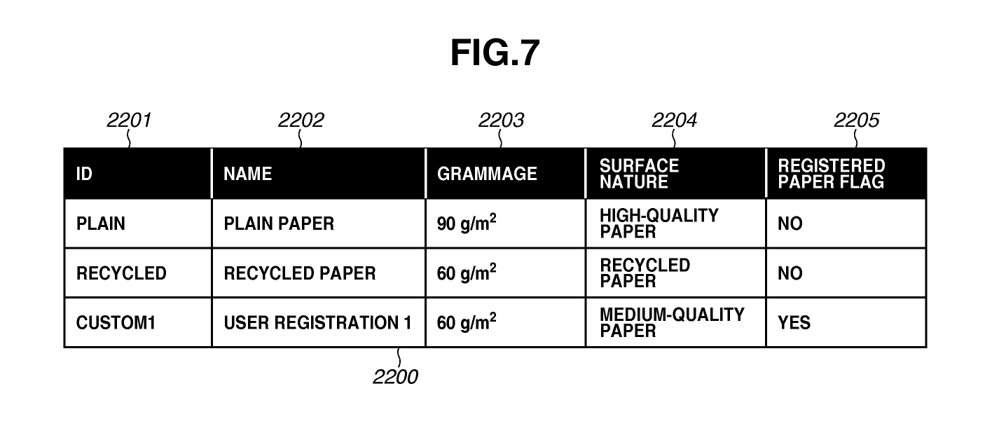

FIG. 7 is a diagram illustrating an example of a paper type database 2200 managed in the printing apparatus according to the present exemplary embodiment.

With reference to FIG. 7, the paper type database 2200 is a database for managing information on the types of paper that can be used in the printer 20. The paper type database 2200 is stored in the external memory 211 of the printer 20 and is managed by the printer controller 26. Registration or input of information on a new paper type by using the screen 2101 and the screen 2102 are reflected in the paper type database 2200 by the printer controller 26.

As attributes in the database, the ID 2201, the name 2202, the grammage 2203, the surface nature 2204, and the registered paper flag 2205 are defined. The elements in the database are roughly classified into paper types that are available in the printer 20 from the beginning and paper types that are registered by the user at a later timing. The attribute of the registered paper flag 2205 is NO for the former and YES for the latter.

The values, such as “PLAIN” and “RECYCLED” are defined in advance for the ID 2201 of the paper types that are available from the beginning, and a unique ID, such as a value of “CUSTOM1”, is assigned to a paper type that is registered at a later timing when the paper type is registered.

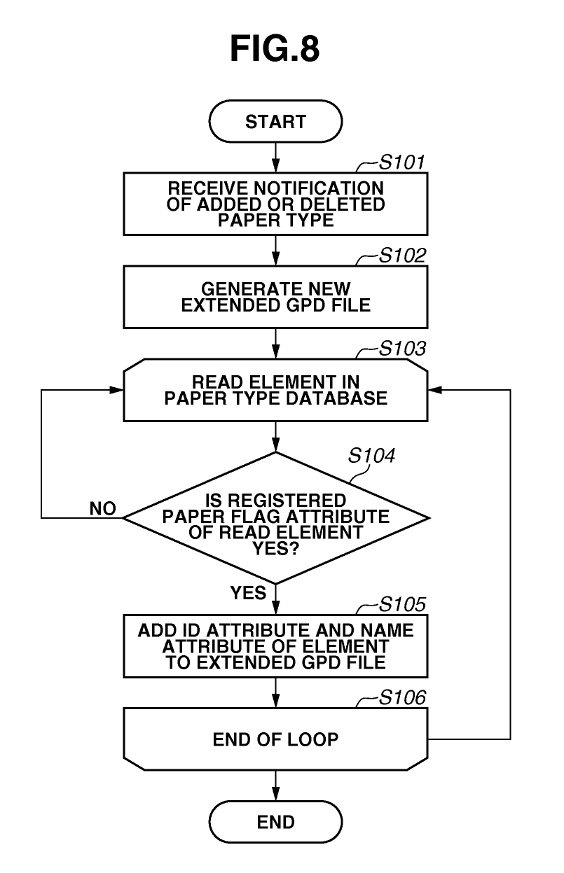

FIG. 8 is a flowchart illustrating data processing in the printing apparatus according to the present exemplary embodiment. According to the present example, the function extension module 27 of the printer 20 illustrated in FIG. 3 generates an extended GPD file. Each of the steps is implemented in such a manner that the CPU 201 executes a control program stored in the ROM 203 or the external memory 211. In the description described below, a module executed by the CPU 201 will be described as an agent.

In step S101, the function extension module 27 receives, from the printer controller 26, a notification indicating that the paper type database 2200 has been modified, or in other words, a notification indicating that a new paper type has been added or a paper type has been deleted. In step S102, the function extension module 27 generates a new extended GPD file. Although an extended GPD file is stored in the external memory 211, a new extended GPD file is created each time a paper type is added or deleted, and thus an extended GPD file stored before start of the process is deleted.

In step S103, the function extension module 27 accesses the paper type database 2200 and reads the elements, one by one, from the top of the list.

In step S104, the function extension module 27 determines whether the attribute of the registered paper flag 2205 of the read element is YES. In a case where the function extension module 27 determines that the attribute is YES (YES in step S104), the processing proceeds to step S105. In a case where the function extension module 27 determines that the attribute is NO (NO in step S104), the processing returns to step S103, so that the function extension module 27 reads a subsequent element.

In step S105, the function extension module 27 adds the ID attribute and the name attribute of the read element (of the paper type added at a later timing) to the extended GPD file. FIG. 5B illustrates an example of the extended GPD file 1712 generated through the process described above. The extended GPD file 1712 is different from the GPD file 1711 and defines only the function information relating to the paper type added at a later timing.

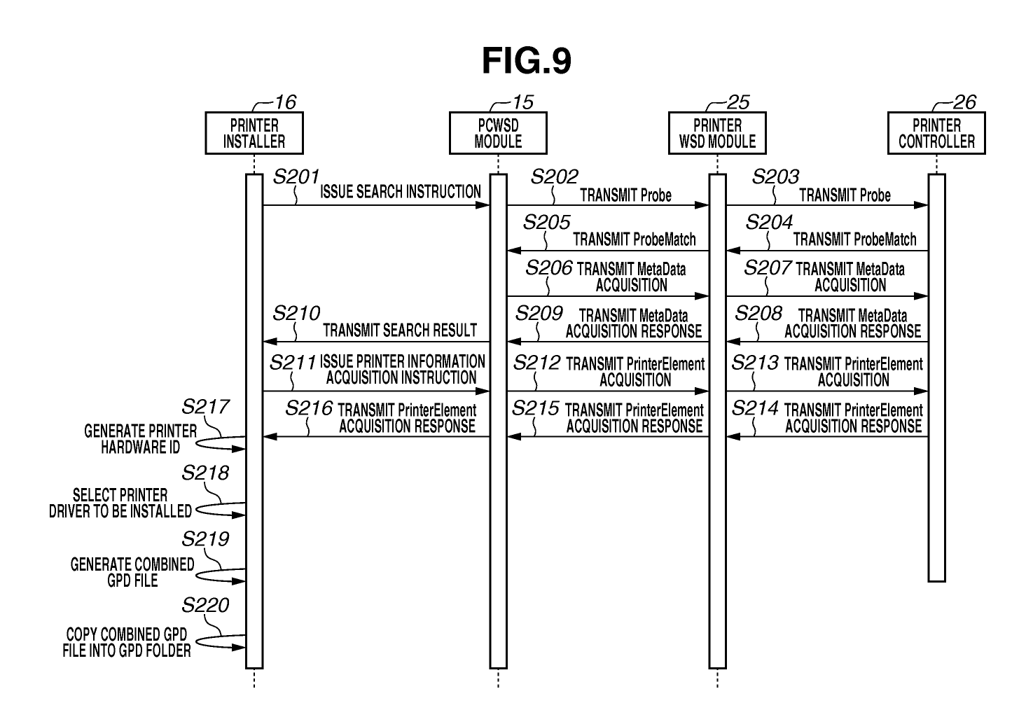

FIG. 9 is a diagram illustrating a process of the software in the printing system according to the present exemplary embodiment. Hereinafter, with reference to FIGS. 9 to 12A through 12B, a process of installing the printer driver 17 according to a first exemplary embodiment will be described. Hereinafter, a driver processing method will be described.

In step S201, upon receiving a search instruction from a user to search for a printer driver, the printer installer 16 issues a search instruction to the PCWSD module 15.

In step S202, upon receiving the search instruction from the printer installer 16, the PCWSD module 15 generates a Probe message 2301 and transmits the Probe message 2301 to the printer 20.

WSD communication of the PC 10 is relayed via the SOAP processor 14, the HTTP protocol stack 13, the TCP/UDP/IP protocol stack 12, the Ethernet controller 11, and the network I/F 105, but this feature will be omitted in the description described below.

In step S203, upon receiving the Probe message 2301, the printer WSD module 25 transmits the Probe message 2301 to the printer controller 26 and requests the printer controller 26 to generate a ProbeMatch message 2302.

WSD communication of the printer 20 is relayed via the network I/F 205, the Ethernet controller 21, the TCP/UDP/IP protocol stack 22, the HTTP protocol stack 23, and the SOAP processor 24, but this feature will be omitted in the description described below.

In step S204, the printer controller 26 generates the ProbeMatch message 2302 and transmits the ProbeMatch message 2302 to the printer WSD module 25. In step S205, the printer WSD module 25 transmits the ProbeMatch message 2302 to the PC 10. Here, a Probe is a message that is transmitted in order to search for a WSD-supported device connected to the LAN 1, and the ProbeMatch is a response message to the Probe.

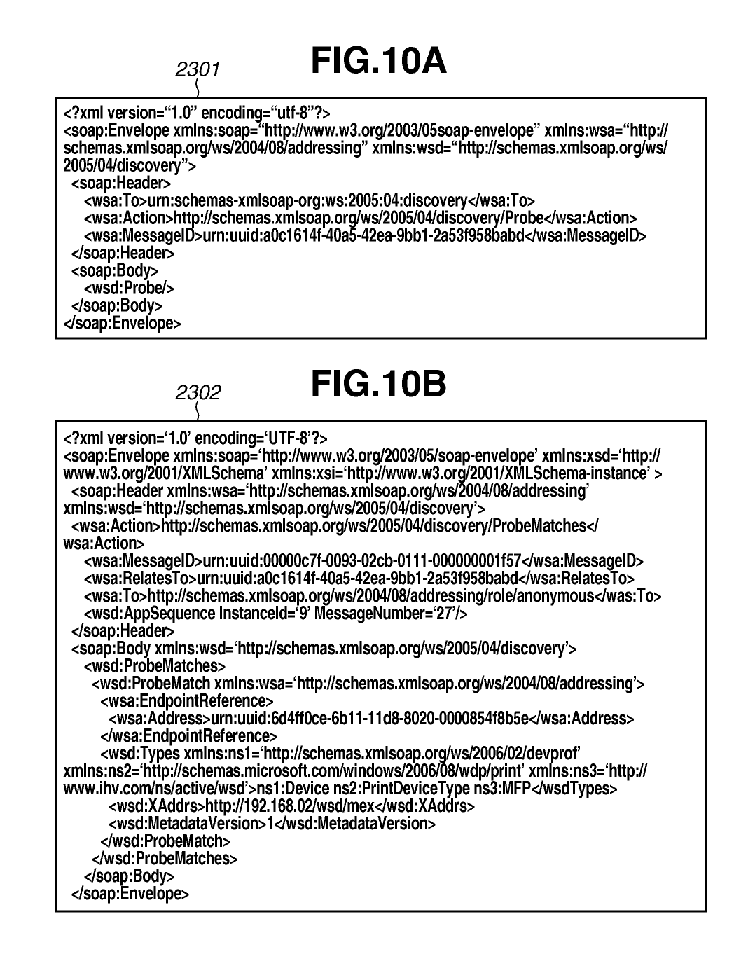

FIG. 10A is a diagram illustrating an example of a Probe message 2301, and FIG. 10B is a diagram illustrating an example of a ProbeMatch message 2302.

The ProbeMatch message 2302 for response includes information on the type of the device, a uniform resource locator (URL) for acquiring MetaData, and the like. The MetaData is data in which information on the name of the printer, the URL for the printer service, and the like is put together.

In step S206, the PCWSD module 15 generates a MetaData acquisition message 2401 based on the URL information for acquiring the MetaData, which has been acquired from the ProbeMatch message 2302, and transmits the MetaData acquisition message 2401 to the printer 20.

In step S207, upon receiving the MetaData acquisition message 2401, the printer WSD module 25 transmits, to the printer controller 26, the MetaData acquisition message 2401 corresponding to an acquisition request, and requests the printer controller 26 to generate a MetaData acquisition response message 2402.

In step S208, the printer controller 26 generates the MetaData acquisition response message 2402 and transmits the MetaData acquisition response message 2402 to the printer WSD module 25. In step S209, the printer WSD module 25 transmits the MetaData acquisition response message 2402 to the PC 10.

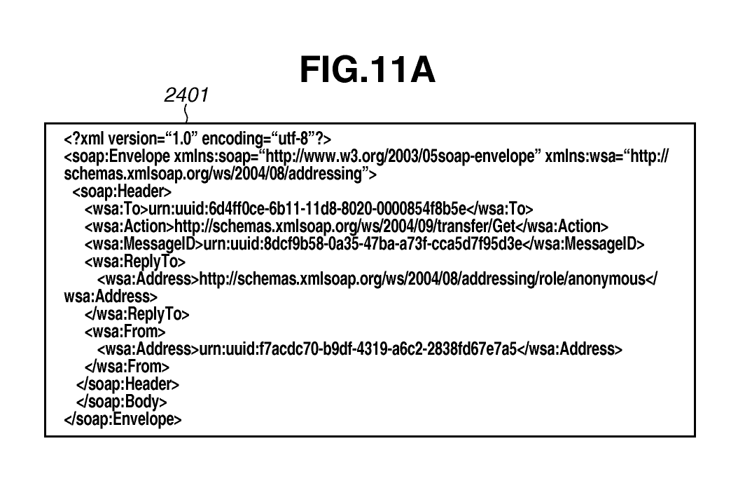

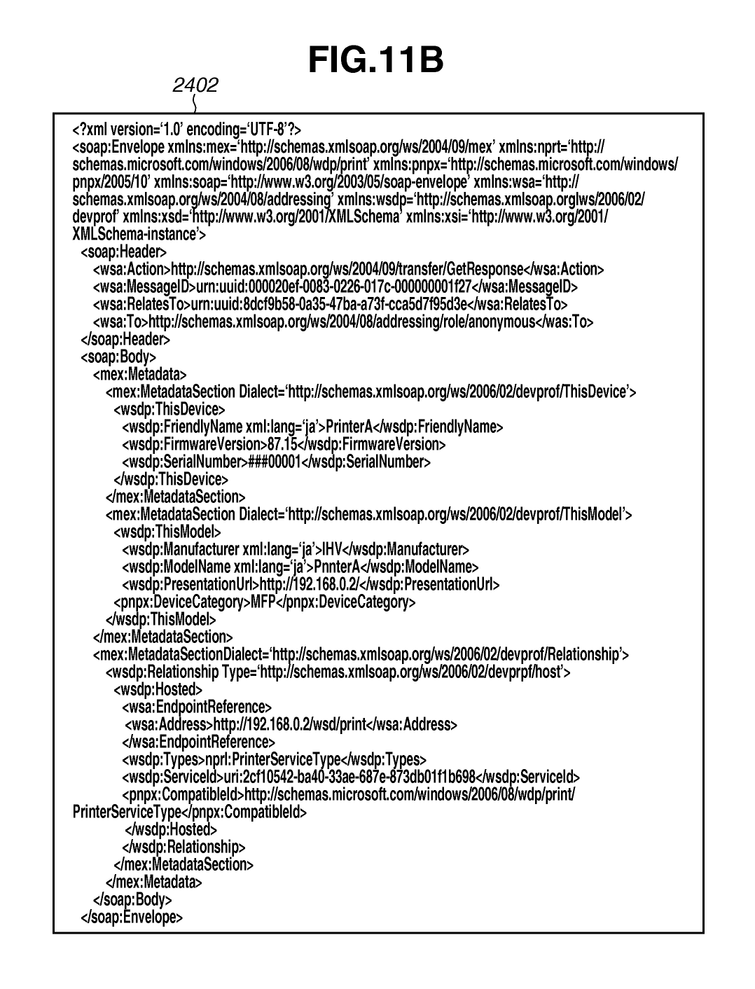

FIG. 11A is a diagram illustrating an example of the MetaData acquisition message 2401, and FIG. 11B is a diagram illustrating an example of the MetaData acquisition response message 2402.

The MetaData acquisition response message 2402 for response includes information on the name of the printer, the URL for the printer service, and the like.

In step S210, upon receiving the MetaData acquisition response message 2402, the PCWSD module 15 transmits, to the printer installer 16, information on the printer name and the like acquired from the MetaData acquisition response message 2402 as a search result. Described above is the search process, and the steps described hereinafter are related to installation.

In step S211, when the user inputs an instruction indicating that the printer driver 17 corresponding to the printer 20 included in the search result is to be installed, the printer installer 16 issues a printer information acquisition instruction to the PCWSD module 15.

In steps S212 through S215, the PCWSD module 15 transmits a PrinterElement acquisition message 2501, and acquires a response to the PrinterElement acquisition message 2501 via the printer WSD module 25 and the printer controller 26.

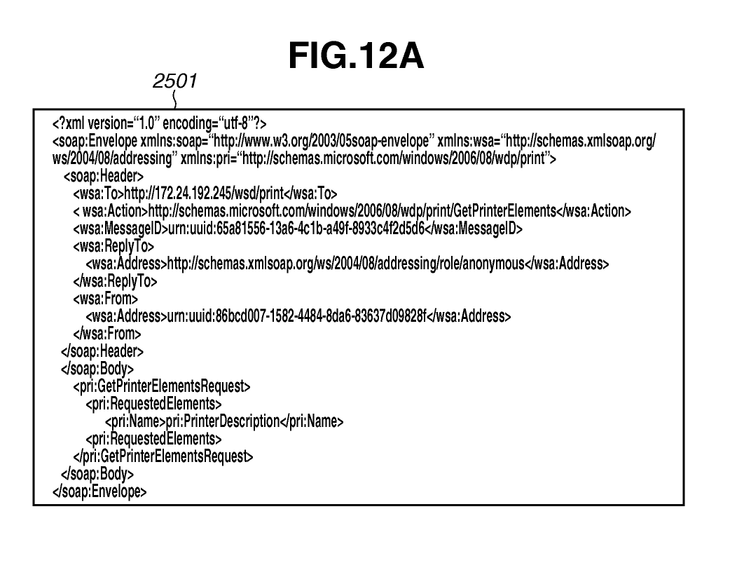

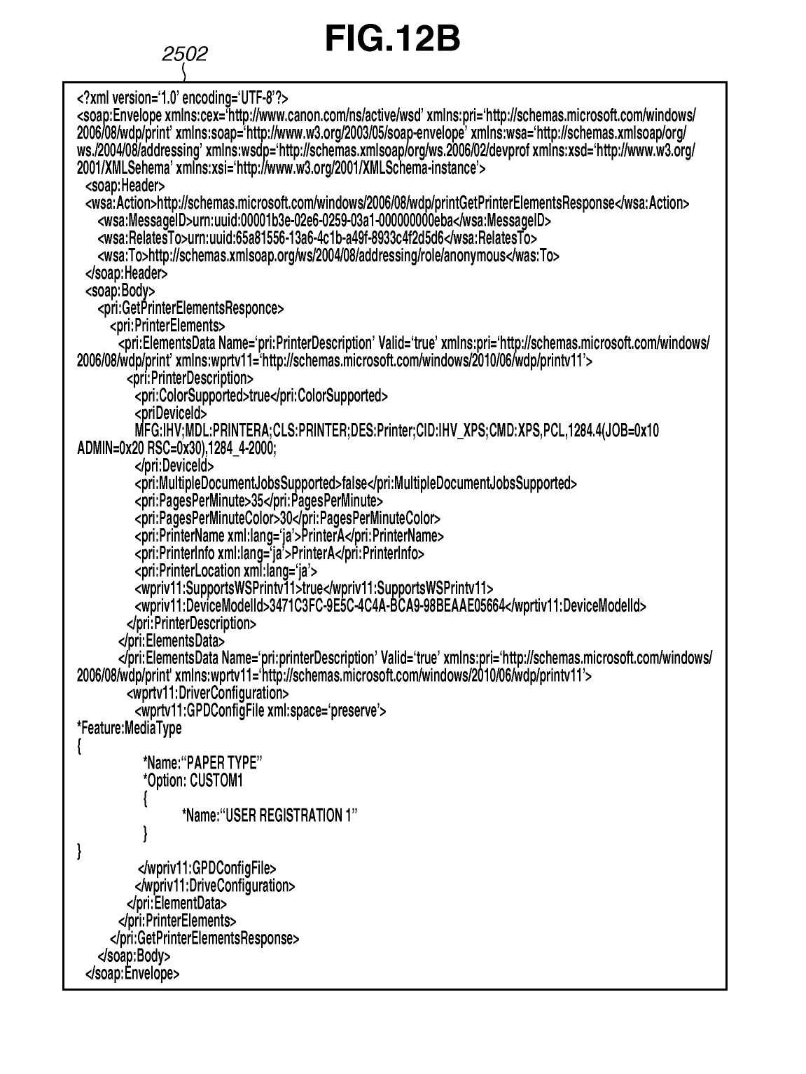

FIG. 12A is a diagram illustrating an example of the PrinterElement acquisition message 2501, and FIG. 12B is a diagram illustrating an example of a PrinterElement acquisition response message 2502.

The PrinterElement acquisition response message 2502 includes device ID information and information on the extended GPD file 1712. The PrinterElement acquisition response message 2502 also includes information on color printing capabilities and a printing speed.

In step S216, the PCWSD module 15 transmits the PrinterElement acquisition response message 2502 to the printer installer 16.

In step S217, upon receiving the PrinterElement acquisition response message 2502, the printer installer 16 generates the printer hardware ID 1700 based on the device ID information included in the PrinterElement acquisition response message 2502. The device ID information is information on which the printer hardware ID 1700 is based.

The value “IHVPRINTERA” in the printer hardware ID 1700 is obtained by combining the values “MFG:IHV” and “MDL:PRINTERA” included in the device ID information.

In step S218, the printer installer 16 searches the driverstore 301 for a printer driver having a hardware ID that matches the printer hardware ID 1700 of the printer 20 obtained in step S217 and selects a printer driver.

As described with reference to FIG. 4, according to the present exemplary embodiment, the printer driver 17 has the hardware ID 17102 that matches the printer hardware ID 1700, and thus the printer driver 17 is selected as the printer driver to be installed.

In step S219, the printer installer 16 combines the extended GPD file 1712 included in the PrinterElement acquisition response message 2502 and the GPD file 1711 so as to generate a combined GPD file 1713.

In step S220, the printer installer 16 copies the combined GPD file 1713 into the GPD folder 302, and the installation process is completed. FIG. 5C is a diagram illustrating an example of the combined GPD file 1713.

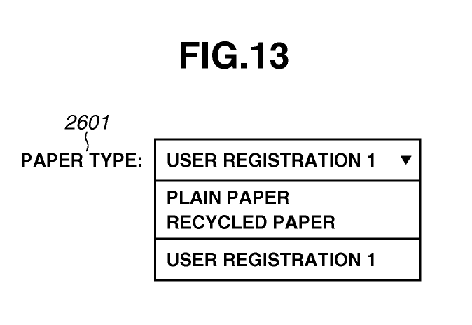

Upon reading the combined GPD file 1713 stored in the GPD folder 302, the printer driver 17 generates a UI screen 2601 that lists the paper types indicated in the screen example illustrated in FIG. 13. Through this process, the print setting function is extended.

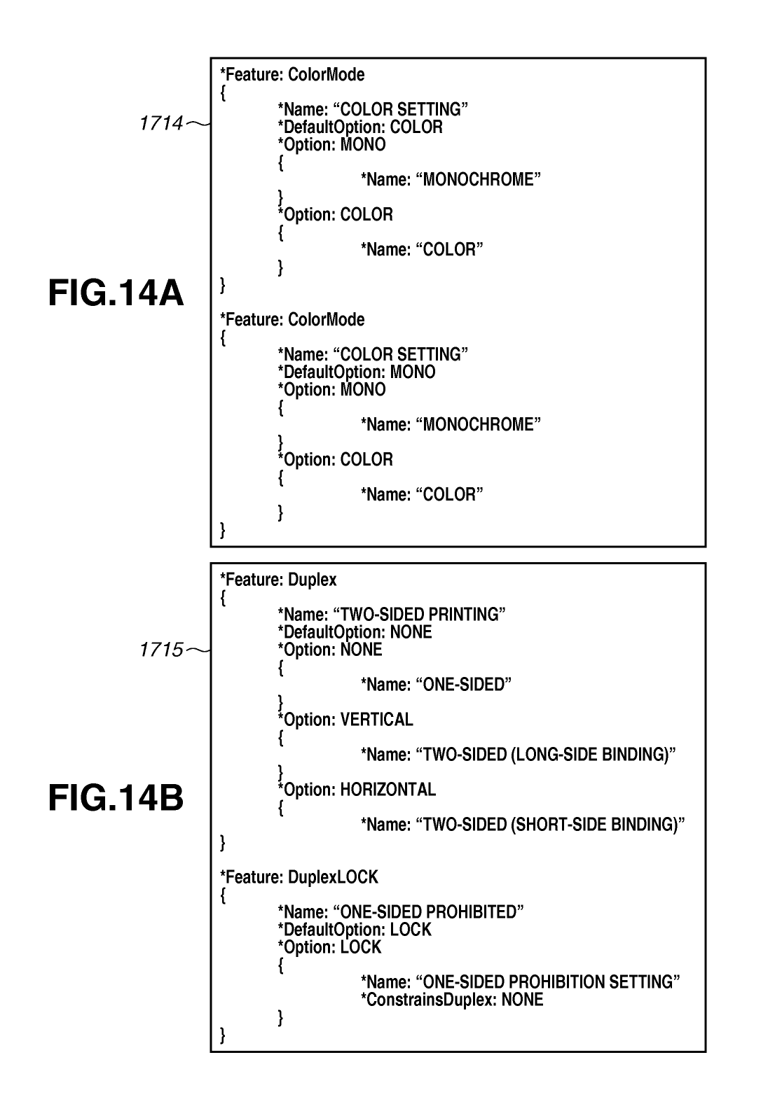

In the foregoing description, a case in which a paper type is added has been described. With reference to FIGS. 14A and 14B, a device setting change by changing a default setting or deactivating some of the functions will be described.

FIG. 14A is a diagram illustrating an example of an extended GPD file 1714 that is generated when a default value of the color setting has been changed from color to monochrome in the printer 20.

The setting in the first half is a definition in the original GPD file, in which the setting of the default value (DefalutOption attribute) indicates COLOR, and the definition in the extended GPD in the second half indicates MONO. When the extended GPD file 1714 is read into the printer driver 17, the second half overrides the first half, and the setting in the second half becomes valid. Therefore, the default setting in the installed printer driver 17 becomes monochrome.

FIG. 14B is a diagram illustrating an example of an extended GPD file 1715 that is generated when a one-sided printing is disabled in the printer 20.

The setting in the first half is the definition in the original GPD, in which one of the three settings, namely, one-sided printing, two-sided printing (long-side binding), and two-sided printing (short-side binding) of the two-sided printing function can be selected.

Meanwhile, in the extended GPD portion in the second half, a function of one-sided printing prohibition (functional restriction information) for preventing the one-sided printing option from being selected in the two-sided printing function is defined.

Through this configuration, when a combined GPD file of the extended GPD file 1715 is read in to the printer driver 17, the one-sided printing option becomes unavailable in the user interface, and the user instead has to select either the two-sided printing option (long-side binding) or the two-sided printing option (short-side binding). A second exemplary embodiment for implementing the present invention will be described.

According to the first exemplary embodiment, a device setting change of the printer is reflected on an installed printer driver. The assumption is that the printer driver is installed after the device setting change is performed.

According to the second exemplary embodiment, a device setting change is reflected on a printer driver installed in advance.

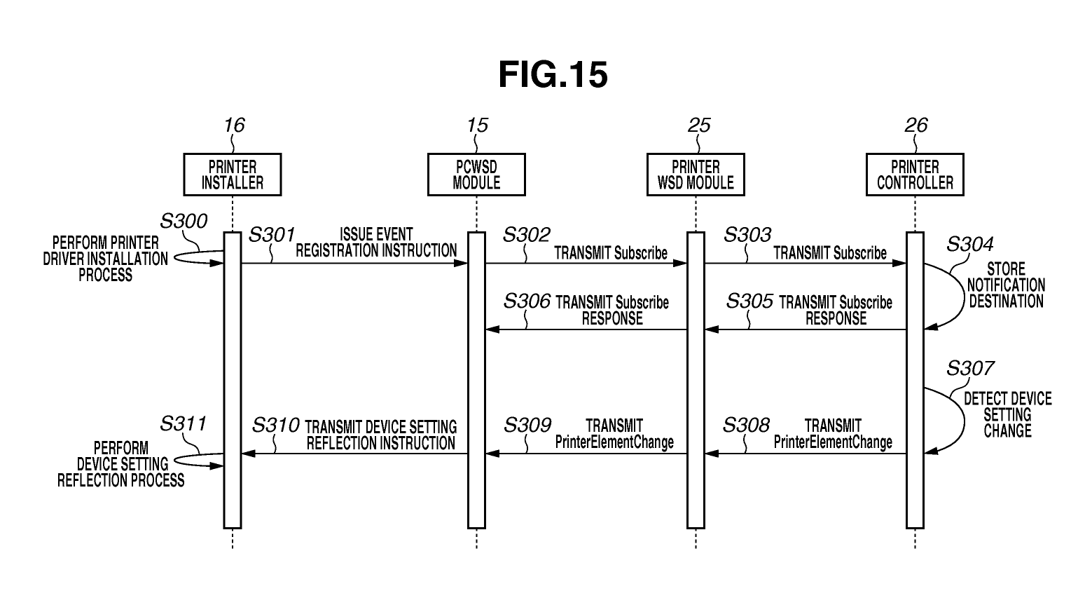

FIG. 15 is a diagram illustrating a process of software in the printing system according to the present exemplary embodiment. Hereinafter, an example of reflection process in which a device setting change is reflected on the printer driver 17 according to the second exemplary embodiment will be described. Hereinafter, a driver processing method will be described.

In step S300, the printer installer 16 performs an installation process of the printer driver 17. Step S300 corresponds to a series of processes in steps S201 through S220 described with reference to FIG. 9 in the first exemplary embodiment. In step S301, the printer installer 16 issues an event registration instruction to the PCWSD module 15.

In step S302, upon receiving the event registration instruction from the printer installer 16, the PCWSD module 15 generates a Subscribe message and transmits the Subscribe message to the printer 20. In step S303, upon receiving the Subscribe message, the printer WSD module 25 transmits the Subscribe message to the printer controller 26.

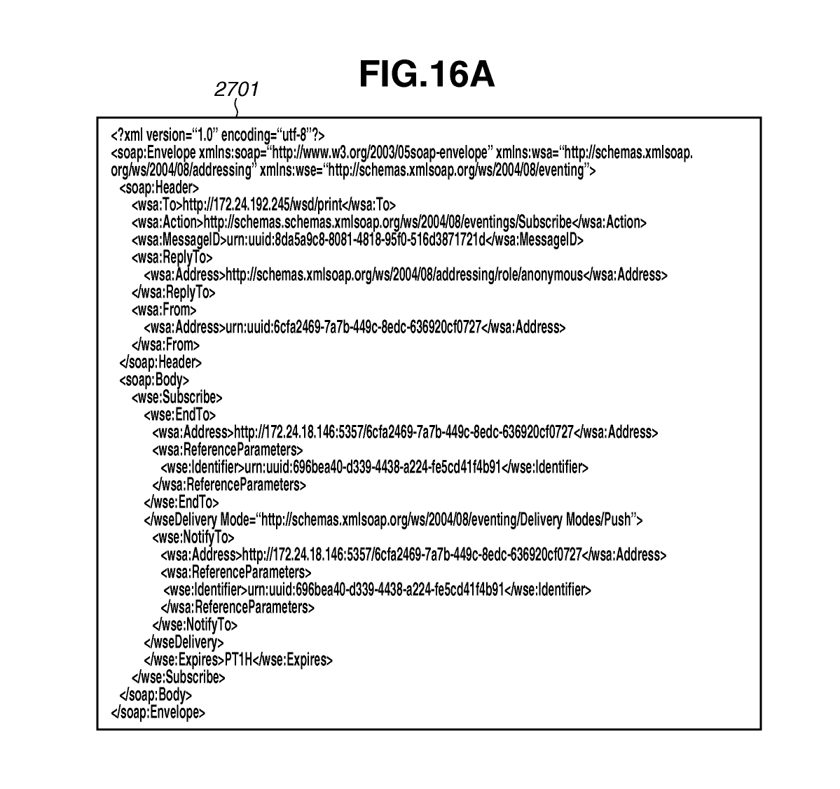

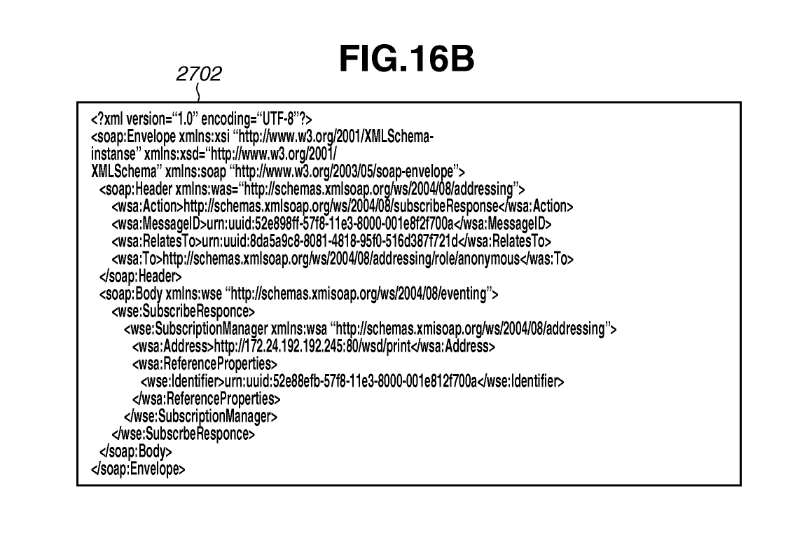

FIG. 16A is a diagram illustrating an example of a Subscribe message 2701. The Subscribe message 2701 includes information on the address of the PC 10, which is the destination of a notification of a device configuration change or a device setting change in the printer 20.

In step S304, the printer controller 26 stores the address of the PC 10 serving as an event notification destination in the external memory 211, and in step S305, the printer controller 26 transmits a Subscribe response message to the printer WSD module 25.

In step S306, the printer WSD module 25 transmits the Subscribe response message to the PCWSD module 15.

FIG. 16B is a diagram illustrating an example of a Subscribe response message 2702. The Subscribe response message 2702 is a message indicating that the event registration has been completed. The processes in steps S300 through S306 described above are performed in series without reception of input from a user in the processes, and the processes in step S307 and thereafter are started when the user inputs a device setting change.

In step S307, upon detecting a device setting change performed by the user, the printer controller 26 generates an extended GPD file based on changed device setting information by using the function extension module 27. Step S307 is a process that is similar to, for example, the process of adding a newly registered paper type to the definition in the extended GPD by the function extension module 27 described in steps S101 through S106.

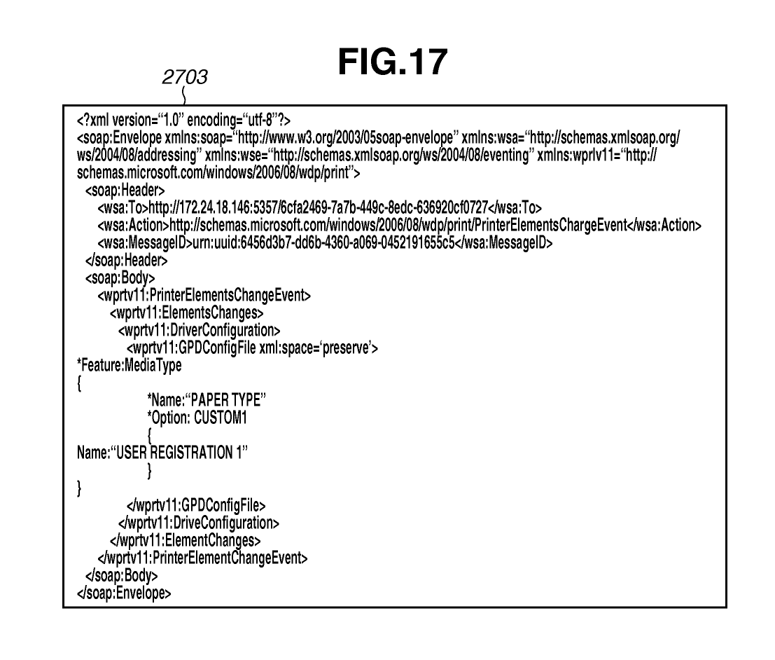

In step S308, the printer controller 26 transmits a PrinterElementChange message to the printer WSD module 25. In step S309, the printer WSD module 25 transmits the PrinterElementChange message to the PCWSD module 15. FIG. 17 is a diagram illustrating an example of a PrinterElementChange message 2703.

The PrinterElementChange message 2703 is a message for notifying the PC 10 of a detected device setting change in the printer 20 and, according to the present exemplary embodiment, includes information on the extended GPD file generated in step S306.

In step S310, upon receiving the PrinterElementChange message, the PCWSD module 15 transmits a device setting reflection instruction to the printer installer 16. Thus, the information on the extended GPD file included in the PrinterElementChange message is transmitted to the printer installer 16 in accordance with the device setting reflection instruction.

In step S311, upon receiving the device setting reflection instruction, the printer installer 16 performs a device setting reflection process. The device setting reflection process is a process in which the extended GPD file is applied to the installed printer driver 17 so as to change the printing function.

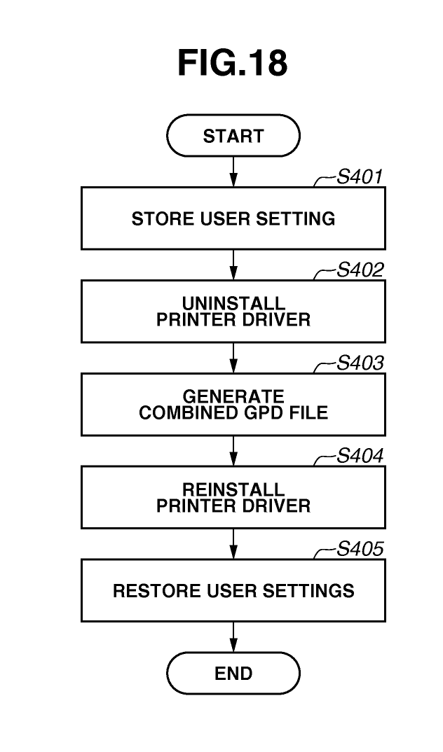

FIG. 18 is a flowchart illustrating a driver processing method in the information processing apparatus according to the present exemplary embodiment. This example corresponds to an example of the device setting reflection process. Each of the steps is implemented in such a manner that the CPU 101 executes a control program (module) stored in the external memory 111.

First, in step S401, the printer installer 16 stores a user setting associated with the printer driver 17. Here, the user setting refers to an output destination port setting or a default print setting.

The process in step S401 is for storing such a user setting in order for the user setting to be inherited to the printer driver to which the extended GPD file has been applied. In step S402, the printer driver 17 that has once been installed is uninstalled.

In step S403, the extended GPD file 1712 illustrated in FIG. 5B is combined with the GPD file 1711 illustrated in FIG. 5A, and the combined GPD file 1713 illustrated in FIG. 5C is thus generated. In step S404, the combined GPD file 1713 is copied into the GPD folder 302 illustrated in FIG. 4, and the printer driver 17 is thus reinstalled. The reinstalled printer driver 17 reads the combined GPD file 1713 stored in the GPD folder 302, and the device setting change is reflected.

In step S405, the user setting stored in step S401 is applied to the reinstalled printer driver 17, and thus a state before the reinstallation is restored.

The process of reflecting a device setting change onto a pre-installed printer driver has been described.

Each of the steps in the exemplary embodiments of the present invention can also be implemented by a processing device (CPU, processor) of a personal computer (computer) executing software (program) acquired through a network or in the form of various types of storage media.

The present invention is not limited to the exemplary embodiments described above. Various modifications (including an organic combination of the exemplary embodiments) can be made in accordance with the spirit of the present invention, and such modifications are encompassed within the scope of the present invention.

According to the present invention, as a function setting file that defines a function set to a printer driver to be installed is edited, a printer driver that is suitable for an environment of the function setting file intended by a user can be installed.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-118622, filed Jun. 9, 2014, which is hereby incorporated by reference herein in its entirety.

What is claimed is:

1. A system, comprising:
a printing apparatus; and
an information processing apparatus,
wherein the printing apparatus includes:
a storage unit configured to store information input by a user operation,
a generation unit configured to generate an extended file based on the information stored by the storage unit, and
a transmission unit configured to transmit the extended file to the information processing apparatus, and
wherein the information processing apparatus includes:
a reception unit configured to receive the extended file from the printing apparatus, and
an extension unit configured to extend a print setting function based on the extended file.

2. The system according to claim 1,
wherein the storage unit stores information on an added paper type as the information, and
wherein the extension unit extends the print setting function by displaying the added paper type as a choice for a paper type on a print setting screen, based on the information on the added paper type.

3. The system according to claim 1,
wherein the information processing apparatus further includes a search unit configured to search for a printing apparatus on a network, and
wherein the transmission unit transmits the extended file as a response to the search unit.

4. The system according to claim 1, wherein the transmission unit transmits information relating to a color printing capability together with the extended file.

5. The system according to claim 1, wherein the extension unit extends a print setting function of a printer driver installed in the information processing apparatus.

6. A printing apparatus, comprising:
a storage unit configured to store information input by a user operation;
a generation unit configured to generate an extended file based on the information stored by the storage unit; and
a transmission unit configured to transmit the extended file to an information processing apparatus,
wherein a print setting function of the information processing apparatus is extended based on the extended file.

7. The printing apparatus according to claim 6,
wherein the storage unit stores information on an added paper type as the information, and
wherein the information processing apparatus extends the print setting function by displaying the added paper type as a choice for a paper type on a print setting screen, based on the information on the added paper type.

8. The printing apparatus according to claim 6, wherein the transmission unit transmits the extended file as a response to a search by the information processing apparatus.

9. The printing apparatus according to claim 6, wherein the transmission unit transmits information relating to a color printing capability together with the extended file.

10. A control method, comprising:
storing information input by a user operation;
generating an extended file based on the information stored by the storing; and
transmitting the extended file to an information processing apparatus,
wherein a print setting function of the information processing apparatus is extended based on the extended file.

11. The control method according to claim 10,
wherein the storing stores information on an added paper type as the information, and
wherein the information processing apparatus extends the print setting function by displaying the added paper type as a choice for a paper type on a print setting screen, based on the information on the added paper type.

12. The control method according to claim 10, wherein the transmitting transmits the extended file as a response to a search by the information processing apparatus.

13. The control method according to claim 10, wherein the transmitting transmits information relating to a color printing capability together with the extended file.

14. A recording medium storing a program that causes a computer to execute:
storing information input by a user operation;
generating an extended file based on the information stored by the storing; and
transmitting the extended file to a computer,
wherein a print setting function of the computer is extended based on the extended file.

15. The recording medium according to claim 14,
wherein the storing stores information on an added paper type as the information, and
wherein the computer extends the print setting function by displaying the added paper type as a choice for a paper type on a print setting screen, based on the information on the added paper type.

16. The recording medium according to claim 14, wherein the transmitting transmits the extended file as a response to a search by the computer.

17. The recording medium according to claim 14, wherein the transmitting transmits information relating to a color printing capability together with the extended file.
